(19) United States
(12) Patent Application Publication
(10) Pub. No.: US 2008/0109467 A1
(43) Pub. Date: May 8, 2008

(54) DATA ENTITY CENTRIC APPROACH FOR DESIGNING WORKFLOWS

(75) Inventors: Tim Brookins, West Fargo, ND (US); Sean Ryan, Sammamish, WA (US); Steve Anonsen, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/556,502

(22) Filed: Nov. 3, 2006

(51) Int. Cl. G06F 17/30

(52) U.S. Cl. 707/102; 707/E17.044

(57) ABSTRACT

A designer tool is provided to assist a user in creating and modifying business process workflows. The user can select a data entity as a focal point for a workflow and a user friendly design experience is provided that takes advantage of semantic relationships between the entity and other elements such as entities and business logic operations that are part of a relationship model. For example, given a selected entity, the application design module can present related operations for the entity on a user interface where the entity is an input parameter.

### BACKGROUND

Businesses currently use a variety of mechanisms to control and analyze business operations such as accounting, payroll, human resources, sales orders, employee tracking, customer relations tracking, etc. Tools that provide these functions are often implemented using computer software. A software package may provide a user interface in order for a user to easily enter and view data corresponding to the various business operations. The software package is also configured to access and update the data, which is stored in a database.

Current software packages can include one or more workflows to implement a business process. These workflows include a number of steps performed in a sequence to complete the business process. For example, a workflow that fulfills a purchase order for an item can include receiving the order to purchase, sending a confirmation, sending the item and printing an invoice. Software packages that implement these workflows can be expensive to design and customize for individual businesses.

The discussion above is merely provided for general background information and is not intended to be used as an aid in determining the scope of the claimed subject matter.

### SUMMARY

A designer tool is provided to assist a user in creating and modifying business process workflows. The user can select a data entity as a focal point for a workflow and a user friendly design experience is provided that takes advantage of semantic relationships between the entity and other elements such as entities and business logic operations that are part of a relationship model. For example, given a selected entity, the application design module can present related operations for the entity on a user interface where the entity is an input parameter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of an environment for designing a business application.

FIG. 2 is a block diagram of a framework utilized by an application design module.

FIG. 3 is a block diagram of an exemplary relationship model.

FIG. 4 is a flow diagram of a method for designing a workflow.

FIG. 5 is a block diagram of a user interface.

FIG. 6 is a flow diagram of a method for implementing a business process.

FIG. 7 is a block diagram of a user interface.

FIG. 8 is a block diagram of a computing environment.

### DETAILED DESCRIPTION

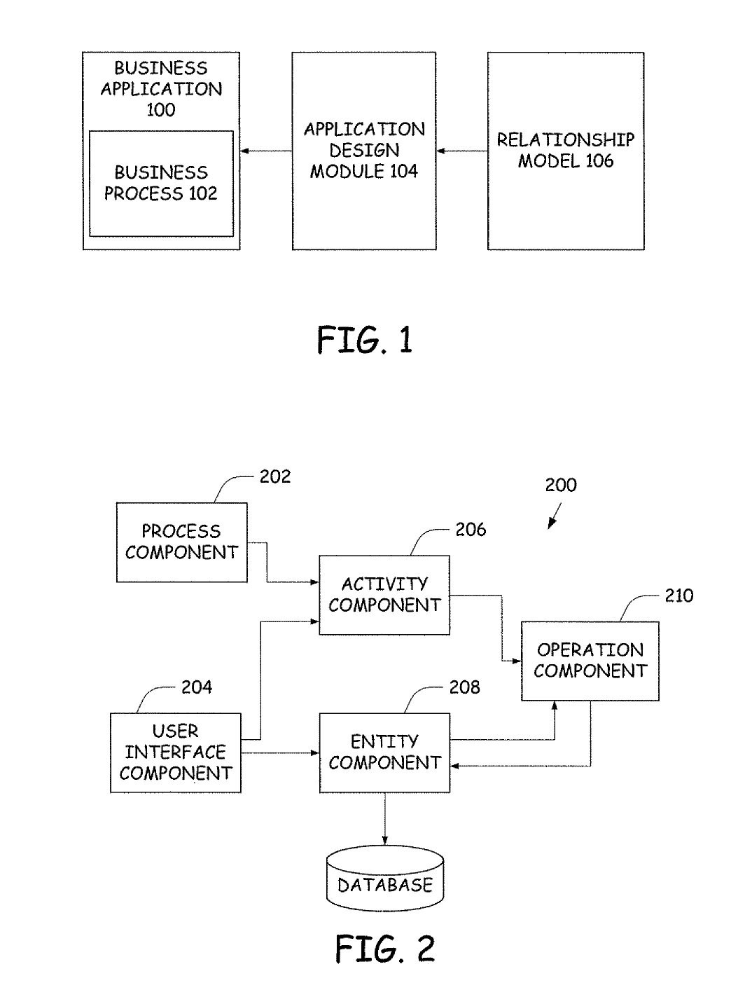

FIG. 1 is a block diagram of an environment utilized by a business application designer for designing a business application. Business application 100 includes at least one business process 102 that implements a business workflow that includes steps. Business process 102 involves data entities (also referred to as objects) that correspond to data stored in a database. Data entities can include one or more properties that associate data values with the entity. Activities are steps arranged in a workflow for execution. Operation activities are implementations of business logic that typically modify data. The process 102 includes a set of activities for performing the workflow. In one embodiment, business process 102 can utilize properties of the entities when implementing the workflow. Application design module 104 utilizes a relationship model 106 to design application 100. Relationship model 106 includes associations for entities and operations to assist the application designer in creating and modifying business process 102 of business application 100. In particular, business model 106 includes relationship information with respect to entities and operations that are associated with the entities. Additionally, relationship model 106 can include relationship information among workflows, entities and operations.

FIG. 2 is a block diagram of a framework utilized by application design module 104 to create and modify business application 100. Framework 200 includes process component 202, user interface component 204, activity component 206, entity component 208, operation component 210 and database 212. Process component 202 defines processes within business application 100, for example business process 102. The process component 202 defines a set of business logic for the application. User interface component 204 defines various interfaces that interact with a user that operates business application 100. Activity component 206 defines operation activities that are used by process component 202 and user interface component 204 to implement business application 100. Example operation activities include allocating inventory, creating lists, creating a packing slip, creating an expense report, etc. Entity component 208 defines entities that are utilized by application 100 as well as properties associated with the entities. Example entities can include a quote, an order, a list, a packing slip, an expense report, etc. Example properties can include amounts, prices, quantities, dates, charges, descriptions, etc. User interface component 202 defines how these entities and associated properties are displayed in application 100. Database 212 is used to store data associated with the entities. Operation component 210 defines operations that are used by activity component 206 and entity component 208. Additionally, activity component 206 can use operation component 210 to bind output from an operation to an entity.

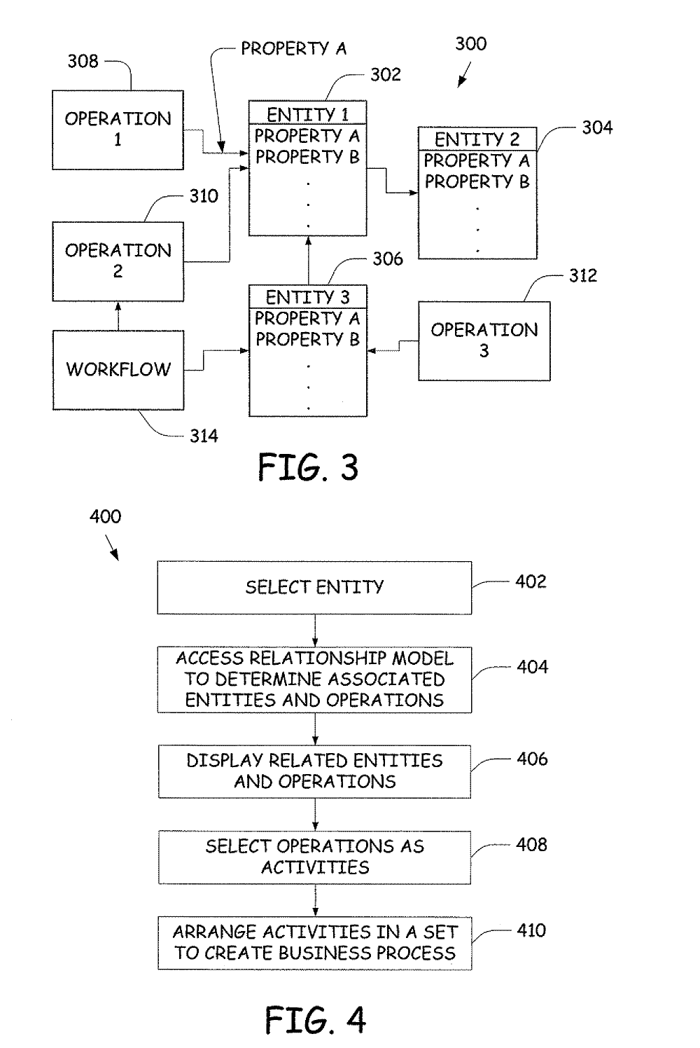

FIG. 3 is a block diagram of a portion of a relationship model, such as relationship model 106. Relationship model 106 identifies relationships between entities and associated operations within application design module 104. In the example illustrated, relationship model 300 includes entities 302, 304 and 306. Each of the entities include associated properties. Additionally, relationship model 300 includes operations 308, 310 and 312. Arrows within relationship model 300 define relationships between associated entities and operations. For example, both operations 308 and 310 provide information to entity 302. Additionally, relationship model 300 can provide information regarding a particular property in an entity that an operation can modify. For example, FIG. 3 illustrates an arrow from operation 308 to entity 302 having an indication labeled “PROPERTY A”, which indicates that operation 308 modifies “PROPERTY A” of entity 302. Other information can also be provided among the arrows in FIG. 3 to augment data provided in relationship model 300. This information can include, for example, cardinality of related elements such as an order entity being associated with zero-to-many order line items and associated with one-and-only-one customer entity. Additionally, model 300 includes a relationship between entity 306 and entity 302 as well as between entity 302 and entity 304. Additionally, operation 312 modifies data associated with entity 306. These relationships are useful in designing a business process for a business application. Relationship model 300 can also include relationship information among workflows, operations and entities. For example, workflow 314 is illustrated as being related to operation 310 and entity 306.

FIG. 4 is a flow diagram of a method for using a relationship model in design of an application. Method 400 begins at step 402, where a designer selects an entity. Once an entity has been selected, a relationship model that defines relationships of entities and activities is accessed at step 404. Relationships of associated operations and entities to the selected entity are displayed at step 406. At this point, the designer can select operations related to the entity as activities at step 408 and arrange them in a set_{[spr1]} to create a process at step 410. Method 400 can return to step 402 for selection of different entities. It will be appreciated that method 400 can also be implemented for modifying an existing business process, wherein a designer selects an existing entity at step 402 while steps 404, 406, 408 and 410 are implemented based on the selected entity.

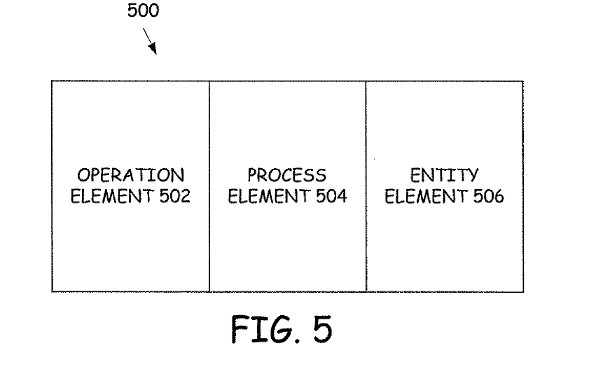

FIG. 5 is a block diagram of a user interface for implementing method 400 of FIG. 4. User interface 500 includes an operation element 502, a process element 504 and an entity element 506. Entity element 506 allows a user to select a particular entity to create or modify within a business application. Once an entity has been selected, entity element 506 can display associated entities from a relationship model and operation element 502 can display associated operations from the relationship model. A user can select an operation within operation element 502 to add as an activity in process element 504. Process element 504 displays activities selected and an arrangement for the activities. In this manner, a user can select an entity for which to create a business process, rather than selecting a particular operation to include as an activity for creating a business process. This ability to select an entity to begin creating a process can provide a beneficial and easy user experience when implementing workflows in the business process.

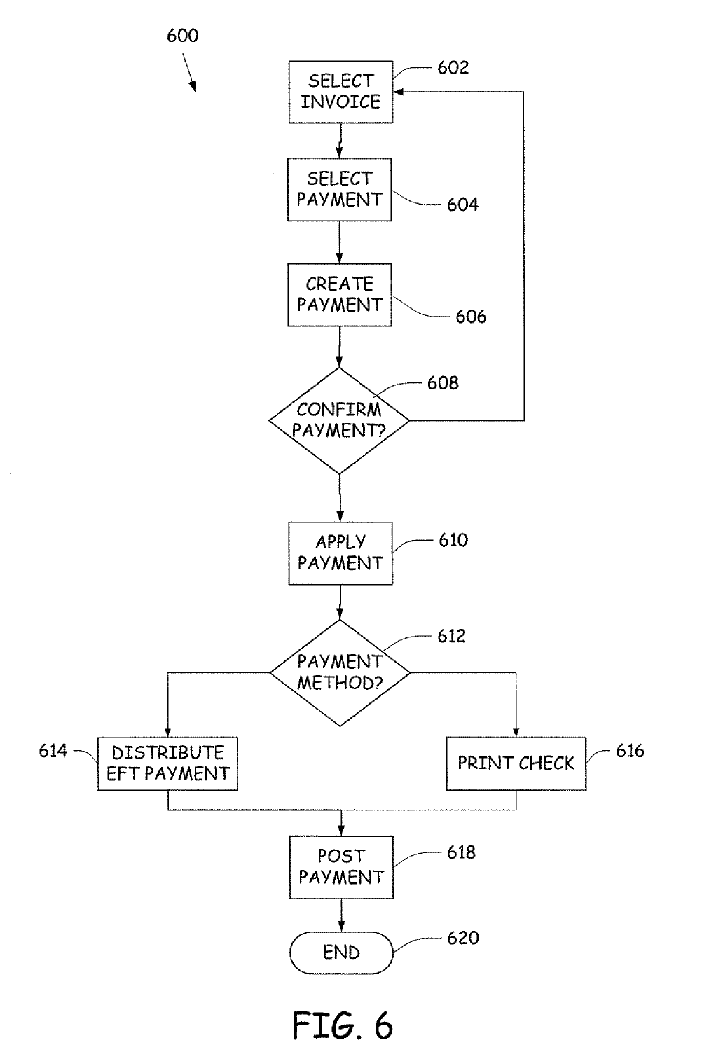

FIG. 6 is a flow diagram illustrating an example business process for paying a supplier. This business process is simplified for illustrative purposes only, and those skilled in the art will readily recognize that other more complex processes can be used with the concepts presented herein. This process will be described with relation to components discussed above as an example implementation. For example, the process can be business process 102 of business application 100 discussed above. The process 102 can be implemented based on business application 100 developed from framework 200.

Business process 600 includes a series of steps. At a number of the steps, the user is presented with a user interface, which allows the user to perform actions for that step in the process. These user interfaces can be defined by user interface component 204 of framework 200. Additionally, each of the steps represent an activity related to an operation.

Prior to beginning the discussion in detail of FIG. 6, a basic overview of the payment process may be helpful. Corporations of various sizes have different processes that they execute prior to actually paying a supplier or even an employee. Due to requirements set by accounting and tax authorities, several documents or papers are generated each time the corporation makes a payment. For example, in some corporations, a user will select which suppliers to pay. Next, the user will create a payment, usually by starting the process of paying the supplier. Once a payment is created, it may be applied to a supplier invoice. In this way, the corporation knows that money has been allocated from one source against the debt.

Next, the user generates the payment. Generation of the payment is similar to writing a check to the supplier. However, in today's complicated business environment, payment is often done electronically, or may even be done against a debt the supplier owes the provider. The final step in the payment process is to post the payment. In this step, for instance, the payment is posted to the general ledger or to the supplier, and all accounts are generally updated to reflect the transaction.

Referring to process 600, the user from a corporation selects an invoice to pay at step 602. At this step, the user can be presented with a user interface defined by user interface component 204 that illustrates a plurality of invoices. Once the user has selected an invoice, a payment from the invoice can be selected at step 604. A user interface can display a number of payments for the invoice. The selected payment is then created at step 606. Next, at step 608, a confirmation is required to create the payment. For example, a manager or other person within the corporation may be required to confirm the payment. If the payment is not confirmed, process 600 can return to step 602, for example. Once payment has been confirmed, process 600 proceeds to step 610, where the payment is applied. For example, the application of the payment can be matched with the invoice selected in step 602. It should be noted that at step 610 the payment is not yet paid, but is sent on for further processing to generate all of the necessary business documents and papers required by the user to effect a payment.

At step 612, the user determines a method of payment. In one embodiment, a user interface can allows the user to select to pay via electronic funds transfer (EFT) or via check. If the user decides to pay via EFT, process 600 proceeds to step 614, wherein the EFT payment is distributed. If the user decides to pay via check, process 600 proceeds to step 616, wherein a check is printed. The payment method can be a property that is used by process 600 when accessing a data entity defining the payment method property. In this case, process 600 can evaluate a condition of the payment method property to determine whether to proceed to step 614 or step 616. After either step 614 or step 616, the user posts the payment thereby updating balance sheets maintained by application 100. Once the payment has been posted, the process for the payment ends at step 620.

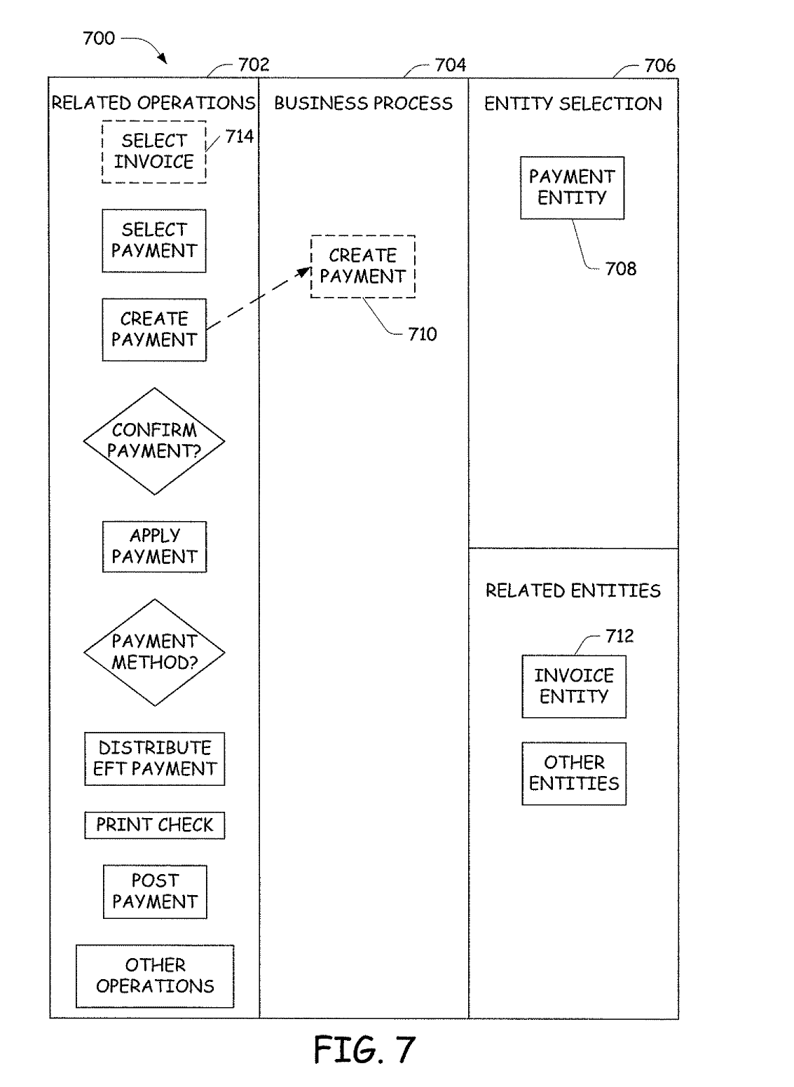

In order to create a business application to implement process 600, a designer can utilize application design module 104 and relationship model 106. FIG. 7 is a block diagram of an exemplary user interface 700 of application design module 104 for implementing process 600 in a business application. User interface 700 includes a related operations element 702, a business process element 704 and an entity selection element 706. Entity selection element 706 allows a designer to select entities for implementing a process. Once an entity is selected, related operations can be displayed in related operations element 702. For example, once payment entity 708 is selected, associated operations and entities are displayed in element 702. These related operations are defined as part of a relationship model and correspond to steps in business process 600.

These operations can be selected as activities for a workflow and arranged in a set in business process element 704, For example, FIG. 7 illustrates a designer selecting create payment operation 710 and arranging it in business process element 704. Other operations can further be selected and arranged in element 704 to create process 600 in an application. For example, a user can select invoice entity 712. If entity 712 is selected, associated operations can further be displayed such as select invoice operation 714. Additionally, entities associated with the payment entity can be displayed such that a user can select other entities. Thus, due to relationship model 106 having the ability to define relationships among entities and activities, a user can easily implement process 600 by selecting an entity. The operations arranged as activities in business process element 704 can easily be rearranged and modified as desired to provide a sequence for the business process.

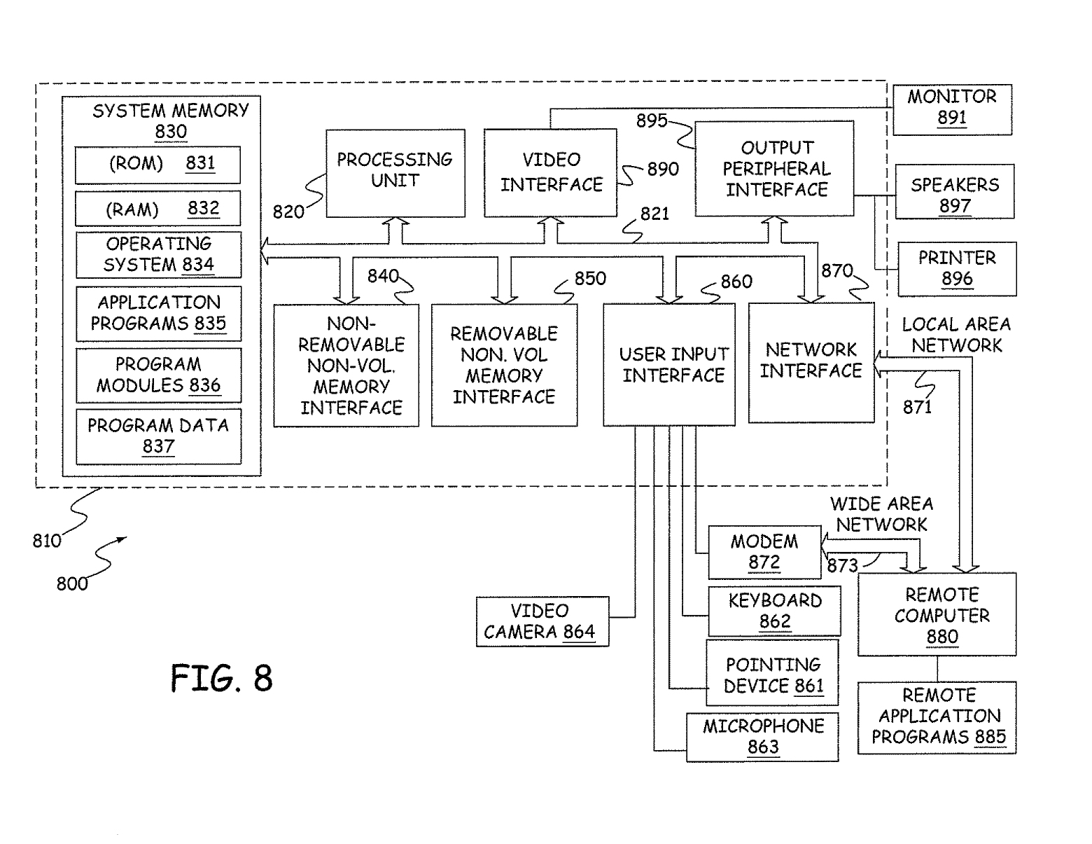

FIG. 8 illustrates an example of a suitable computing system environment 800 on which the disclosure may be implemented. The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the exemplary operating environment 800.

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure is designed to be practiced in distributed computing environments where tasks are performed by remote processing devices that are linked through a communications network. In a distributed computing environment, program modules are located in both local and remote computer storage media including memory storage devices.

With reference to FIG. 8, an exemplary system for implementing the disclosure includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, computer 810 can include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus 821 through a non-removable memory interface such as interface 840, and the magnetic disk drive and the optical disk drive are typically connected to the system bus 821 by a removable memory interface, such as interface 850.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of designing a business process in a business application, comprising:
allowing a user to indicate a selected business entity to implement a workflow;
accessing a relationship model to determine related operations used to transform the selected business entity in the business application; and
displaying the related operations for selection in implementing the workflow.

2. The method of claim 1 further comprising:
accessing the relationship model to determine related business entities associated with the selected business entity; and
displaying the related business entities associated with the selected business entity.

3. The method of claim 1 further comprising:
defining a property associated with the business entity that the workflow uses during implementation.

4. The method of claim 3 further comprising:
allowing the user to indicate a second selected business entity related to the first-mentioned selected business entity.

5. The method of claim 4 further comprising:
accessing the relationship model to determine related operations used to transform the second selected business entity; and
displaying the operations used to transform the second selected business entity.

6. The method of claim 1 further comprising:
allowing the user to arrange an operation related to the selected entity as an activity in the workflow.

7. The method of claim 6 further comprising:
allowing the user to arrange a second operation related to the entity as a second activity in the workflow with respect to the first-mentioned activity.

8. A user interface used to design a business process in a business application, comprising:
a entity selection element allowing a user to indicate a selected business entity; and
a related operations element adapted to display operations used to transform the selected business entity in the business application based on a relationship model.

9. The user interface of claim 8 further comprising:
a related entities element adapted to display related business entities associated with the selected business entity based on the relationship model.

10. The user interface of claim 9 wherein the related entities element allows the user to indicate a second selected business entity related to the first-mentioned selected business entity.

11. The user interface of claim 10 wherein the related activities element is adapted to display related activities used to transform the second selected business entity based on the relationship model.

12. The user interface of claim 8 further comprising:
a process element allowing the user to arrange a related operation as an activity in the business process.

13. The user interface of claim 12 wherein the activity binds the related operation to the business process as a step in the business process.

14. The user interface of claim 12 wherein the process element further allows the user to arrange a second related operation as a second activity in the business process with respect to the first-mentioned activity.

15. A computer-readable medium having instructions for use in designing a business application, comprising:
an application design module defining a plurality of business entities and a plurality of operations used to transform the business entities, the application design module further having a process component defining workflows of activities in a business process, the activities being selected from the plurality of operations; and
a relationship model defining relationships for each of the plurality of business entities with operations from the plurality of operations that are used to transform the selected entities.

16. The computer-readable medium of claim 15 wherein the relationship model further defines, for each of the plurality of business entities, related business entities associated with each of the plurality of business entities.

17. The computer-readable medium of claim 15 wherein the application design module further includes a user interface component adapted to define a display for indicating relationships among entities and between entities and operations.

18. The computer-readable medium of claim 15 wherein the relationship model defines properties within the plurality of business entities and operations that modify the properties.

19. The computer-readable medium of claim 15 wherein the relationship model further defines relationships between workflows and entities and between workflows and operations.

20. The computer-readable medium of claim 15 wherein the activities bind operations to the workflows as steps in the workflows.
